(19) United States
(12) Patent Application Publication
(10) Pub. No.: US 2005/0028915 A1
(43) Pub. Date: Feb. 10, 2005

(54) Tire with reinforcement structure forming internal and external loops

(75) Inventor: Nathan Panning, Simpsonville, SC (US)

Correspondence Address: COHEN, PONTANI, LIEBERMAN & PAVANE, Suite 1210, 551 Fifth Avenue, New York, NY, 10176, US

(73) Assignee: Michelin Recherche et Technique S.A., Granges-Paccot (CH)

(21) Appl. No.: 10/879,989

(22) Filed: Jun. 28, 2004

Related U.S. Application Data
(63) Continuation of application No. PCT/EP02/14722, filed on Dec. 23, 2002.

(30) Foreign Application Priority Data
Dec. 28, 2001 (FR) 01/17135

(51) Int. Cl. B60C 9/07; B60C 9/02; B60C 9/04; B60C 15/00

(52) U.S. Cl. 152/548; 152/562; 152/550; 152/552; 152/539; 152/547; 156/117

(57) ABSTRACT

Tire comprising at least one carcass-type reinforcement structure anchored on either side of the tire in a bead, the reinforcement structure comprising: a first and a second filament each forming on one hand a series of transverse portions extending substantially from one bead of the tire to the other, and on the other hand, U-shaped connections joining two successive transverse portions of said first and second filaments, the first and second filaments being arranged so that, for a given circumferential position of the tire, in a first bead, the first filament forms a radially outer connection, radially inside of which an internal connection formed by the second filament is arranged, and, in the second bead, the second filament forms a radially outer connection, radially inside of which an internal connection formed by the first filament is arranged.

### FIELD OF INVENTION

The present invention relates to tires. More particularly, it relates to the arrangement and the configuration of the reinforcement structure in the sidewalls, the beads and the crown zone of the tire; it also relates to the anchoring of the carcass cords in the bead and the reinforcements of different portions of the bead or the sidewall.

### BACKGROUND OF INVENTION

The reinforcement of tires is currently constituted by one or more plies, conventionally referred to as “carcass plies”, “crown plies”, etc. This method of designating reinforcements derives from the manufacturing process, consisting of producing a series of semi-finished products in the form of plies, provided with frequently longitudinal cord reinforcements, which are subsequently assembled to build a tire.

The plies are produced flat, with large dimensions, and are subsequently cut according to the dimensions of a given product. The plies are also assembled, in a first phase, substantially flat. The blank thus produced is then shaped to adopt the toroidal profile typical of tires. The semi-finished products referred to as “finishing” are then applied to the blank, in order to obtain a product ready for vulcanization.

This same conventional process involves the use of a bead wire, used to effect the anchoring or holding of the carcass ply in the bottom zone of the sidewall. Thus, conventionally, a portion of ply is turned up around a bead wire arranged in the bead of the tire. In this manner, anchoring of the carcass ply in the bead is effected.

The fact that this conventional process has become widespread in the industry, despite numerous variants in the manner of producing the plies and assemblies, has lead the person skilled in the art to use a vocabulary modeled on the process; hence the generally accepted terminology, comprising in particular the terms “plies”, “carcass”, “bead wire”, “shaping” to designate the change from a flat profile to a toroidal profile, etc.

However, there are nowadays tires which do not, properly speaking, comprise “plies” or “bead wires” in accordance with the preceding definitions. For example, document EP 0 582 196 describes tires manufactured without the aid of semi-finished products in the form of plies. For example, the cords of the different reinforcement structures are applied directly to the adjacent layers of rubber mixes, the whole being applied in successive layers on a toroidal core having a shape which makes it possible to obtain directly a profile similar to the final profile of the tire being manufactured.

Thus, in this case, there are no longer any “semi-finished products”, nor “plies”, nor “bead wires”. The base products, such as the rubber mixes and reinforcements in the form of filaments, are applied directly to the core. As this core is of toroidal form, the blank no longer has to be shaped in order to move from a flat profile to a profile in the form of a torus.

Furthermore, the tires described in this document do not have the conventional upturn of the carcass ply around a bead wire. This type of anchoring is replaced by an arrangement in which circumferential filaments are arranged adjacent to said sidewall reinforcement structure, the whole being embedded in an anchoring or bonding rubber mix.

There are also processes for assembly on a toroidal core using semi-finished products specially adapted for quick, effective and simple laying on a central core.

Finally, it is also possible to use a mixed process comprising both certain semi-finished products for producing certain architectural aspects (such as plies, bead wires, etc), whereas others are produced from the direct application of mixes and/or reinforcements in the form of filaments.

In the present document, in order to take into account recent technological developments both in the field of manufacture and in the design of products, the conventional terms such as “plies”, “bead wires”, etc, are advantageously replaced by neutral terms or terms which are independent of the type of process used. Thus, the term “carcass-type reinforcement” or “sidewall reinforcement” is valid to designate the reinforcement cords of a carcass ply in the conventional process, and the corresponding cords, generally applied at the level of the sidewalls, of a tire produced in accordance with a process without semi-finished products.

The term “anchoring zone”, for its part, may equally well designate the traditional upturn of a carcass ply around a bead wire of a conventional process or the assembly formed by the circumferential filaments, the rubber mix and the adjacent sidewall reinforcement portions of a bottom zone produced with a process with application to a toroidal core.

The carcass reinforcement of tires is currently constituted by one or more plies, most frequently radial ones, which are turned up about one or more bead wires arranged in the beads. The beads constitute the means which makes it possible to fix the tire on the rim. The rigidity of the bead thus constituted is very great.

For some specific applications in which the tire may for example be subjected to great loads or to violent impacts, etc., it may prove desirable to be able to refine some characteristics such as rigidity, impact strength, etc. Furthermore, in order to facilitate automation of certain steps of the tire manufacturing process, it may prove advantageous to revise the nature and/or the arrangement of some of the constituent elements.

In the current art, it is quite difficult to modulate the characteristics of the sidewall and/or of the bead. The sidewall must have great flexibility, and the bead, in contrast, must have great rigidity. Furthermore, the reinforcements which are arranged in this part of the tire always inevitably have a discontinuity: at the level of the radially upper end of the carcass upturn, there is a change without transition into a zone devoid of this carcass upturn, which zone is therefore inevitably less rigid.

Finally, the cost demands are becoming increasingly harsh and require productivity gains which are becoming increasingly difficult to obtain, taking into account the ceaselessly increasing technicality of the products. Any method or device which makes it possible to produce tires at faster rates while maintaining the level of quality is therefore potentially advantageous.

### SUMMARY OF THE INVENTION

In order to make allowance for this environment and these constraints, the invention provides a tire comprising at least one reinforcement structure of carcass type anchored on either side of the tire in a bead the base of which is intended to be mounted on a rim seat, a crown reinforcement, each bead being extended radially towards the outside by a sidewall, the sidewalls joining a tread radially towards the outside, the reinforcement structure comprising:
a first filament forming on one hand at the level of the crown and the sidewalls a series of transverse portions extending substantially from one bead of the tire to the other, and on the other hand, at the level of the beads, U-shaped connections joining two successive transverse portions of the first filament,
a second filament forming on one hand at the level of the crown and the sidewalls a series of transverse portions extending substantially from one bead of the tire to the other, and on the other hand, at the level of the beads, U-shaped connections joining two successive transverse portions of the second filament,
the first and second filaments being arranged so that, for a given circumferential position of the tire, in a first bead, the first filament forms a radially outer connection, radially inside of which an internal connection formed by the second filament is arranged, and, in the second bead, the second filament forms a radially outer connection, radially inside of which an internal connection formed by the first filament is arranged.

Such an arrangement is optimal for the bottom portion of the sidewall. The zone of excess thickness is reduced to a minimum, there is no risk of contact between the cords, etc. Furthermore, advantageously the zone of substantially parallel paths of the filaments from the sidewall into the upturn loop itself is extended.

Advantageously, the respective paths of the first and second filaments are arranged such that, between the crown and the bead, a group of filaments formed by a first and a second adjacent filament form at least a portion of substantially parallel paths.

Such an arrangement comprising substantially parallel groups of filaments makes it possible to produce a multifilament configuration very economically. The groups of cords may be applied substantially simultaneously, for example by means of a single laying head. In this manner, and due to the specific type of architecture according to the invention, it is possible to divide by two or even by three or more the time for laying the reinforcement filaments of carcass type, in particular if the production is effected on a central core preformed in the image of a tire.

Furthermore, the arrangement in substantially parallel groups makes it possible to arrange the filaments very close to one another, thus contributing to increasing the cord density. This has a beneficial effect on a good number of mechanical properties. Thus, for example, it may make it possible to increase the modulus, the tensile strength, etc.

Advantageously, the portions of substantially parallel paths represent at least substantially 25% of the total path of the filaments between the crown and the anchoring zone and preferably between substantially 30% and 80% of the total path of the filaments between the crown and the anchoring zone.

Insofar as the cords are laid in pairs or any other grouped form, the laying time is reduced, thus reducing the cost price.

Advantageously, the portions of substantially parallel paths are provided in the sidewall, substantially radially externally to the anchoring zone, and preferably radially externally to the zone corresponding substantially to the equator of said sidewall. The laying in the form of parallel groups is easiest and most precise structurally starting from the equator and moving towards the crown. Preferably, the equator in question is the one corresponding to the equator of the core on which the different constituent elements of the tire are assembled.

According to another advantageous example, the tire comprises a third filament forming on one hand, at the level of the crown and the sidewalls, a series of transverse portions extending substantially from one bead of the tire to the other, and on the other hand, at the level of the beads, U-shaped connections joining two successive transverse portions of the third filament, the respective paths of the first, second and third filaments preferably being arranged such that, between the crown and the bead, a group of filaments formed by a first, a second and a third adjacent (or successive) filament form at least a portion of substantially parallel paths.

The laying time can then be divided by three if the cords are laid in groups. The laying density may also be increased, by substantially similar, close paths of the cords of one and the same group.

At least one arrangement of cords along a substantially circumferential path is preferably arranged substantially adjacent to said reinforcement structure at the level of the bead.

According to another advantageous example, the portions of substantially parallel paths follow substantially geodesic trajectories.

According to another advantageous embodiment, the “forward” and “return” sections of at least two distinct groups cross so as to form a mesh pattern of cords. For example, the portions of substantially parallel paths are arranged so as to form, on a given side of the tire, a trajectory in the form of circumferentially offset forward and return paths. Said trajectory is advantageously V- or U-shaped. One of the forward or return portions runs along the other forward or return portion of a series of juxtaposed filaments, crossing the filaments. The result of such a configuration is braiding of filaments, crossing at angles which are more or less open according to the radial position and/or according to the respective inclination of each of the filaments.

The tire may then comprise a single ply. Such simplicity of architecture and manufacture, due in particular to the reduction in the number of constituents, makes it possible to reduce the costs.

According to another advantageous example of embodiment, a bead comprises a bead wire around which a portion of the cords is wound. This provides effective and reliable anchoring or holding of the reinforcement structure in the bead. This method of anchoring corresponds to a traditional bead wire, which is widespread in the tire industry. Preferably cords of textile type are used in order to facilitate the formation of the loops.

Advantageously, the tire according to the invention may be manufactured by means of a process for manufacturing a tire in which the different constituent elements are laid turn by turn directly on a core, the profile of which corresponds substantially to that of the final product, and in which the laying of a first reinforcement structure on a first side of a tire and of a second reinforcement structure on a second side of said tire are effected substantially simultaneously.

In the case of a tire manufactured using such an automated process in which the different constituent elements are laid turn by turn directly on a core, the profile of which corresponds substantially to that of the final product, the action of laying groups of cords comprising two (or more) cords is particularly advantageous. For example, the result is a great reduction in the laying time for the reinforcement structure.

In the present specification, the term “cord” very generally designates both monofilaments and multifilaments, or assemblies such as cables, yarns or alternatively any equivalent type of assembly, and this whatever the material and the treatment of these cords, for example surface treatment or coating or pre-sizing in order to promote adhesion to the rubber.

As a reminder, “radially upwards” or “radially upper” means towards the largest radii.

“Elasticity modulus” of a rubber mix is understood to mean a secant modulus of extension obtained at a uniaxial deformation of extension of the order of 10% at ambient temperature.

A reinforcement or reinforcing structure of carcass type will be said to be radial when its cords are arranged at 90°, but also, according to the terminology in use, at an angle close to 90°.

It is known that in the current art the carcass ply or plies is/are turned up about a bead wire. The bead wire then performs the function of anchoring the carcass, that is to say, takes up the tension which develops in the carcass cords under the action of the inflation pressure. In the configurations described in the present application, which do not use a bead wire of conventional type, the function of anchoring the reinforcement structure of carcass type is also ensured.

It is also known, still in the prior art, that the same bead wire furthermore performs a function of clamping the bead on its rim. In the configurations described in the present application, which preferably do not use a bead wire of conventional type, the clamping function is also ensured, in particular by the windings of circumferential cords closest to the seat.

It goes without saying that the invention can be used by adding other elements to the bead or to the bottom zone of the tire in general, as some variants will illustrate. Likewise, the invention can be used by multiplying the reinforcement structures of the same kind, or even by adding another type of reinforcement structure.

### BRIEF DESCRIPTION OF THE DRAWINGS

All the details of embodiment are given in the following description, supplemented by FIGS. 1 to 12, in which:

FIGS. 1a and 1b are radial sections showing essentially the sidewalls, the beads and the crown of a first and a second form of embodiment of a tire according to the invention;

FIG. 2 is a diagrammatic representation, viewed from above, of a portion of the reinforcement structure of an example of a tire according to the invention, the two sidewalls being placed flat on either side of the region of the crown;

FIG. 3 is a diagrammatic representation, viewed from above, of a portion of the reinforcement structure of another example of a tire according to the invention, the two sidewalls being placed flat on either side of the region of the crown;

FIG. 4 is a diagrammatic representation, viewed from above, of a portion of the reinforcement structure of another example of a tire according to the invention, the two sidewalls being placed flat on either side of the region of the crown;

FIG. 5 is an enlarged view of the left-hand portion of FIG. 4;

FIG. 6 is a side view of a portion of a non-finished tire according to the invention, in which groups comprising three cords are arranged along paths of bias type;

FIG. 7 is a side view of a portion of a non-finished tire according to the invention, in which groups comprising three cords are arranged along paths of symmetrical-bias type, in which the “forward” sections are symmetrical and inverted relative to the “return” sections, the multiplication of the groups thus involving an arrangement in the form of a braided or mesh pattern of cords;

FIG. 8 is a side view of a portion of a non-finished tire according to the invention, in which groups are arranged along paths of geodesic type;

FIGS. 9a, 9b and 9c are meridian profiles of a variant comprising a conventional bead wire, for example formed of a metal or composite cable;

FIGS. 10a, 10b and 10c illustrate, by means of perspective views of a section of a portion of a tire according to the invention, examples of paths of a reinforcement structure in a group in relation to a circumferential anchoring structure;

FIGS. 11a to 11c illustrate an example of a method which permits the manufacture of tires such as those described in the preceding figures, with the substantially simultaneous laying of at least two cords;

FIG. 12 illustrates an example of a second method which permits the manufacture of tires such as described in FIGS. 1 to 10, with the substantially simultaneous laying of at least two cords, but with laying means different from those illustrated in FIGS. 11a to 11c.

In the different figures, identical reference numerals are used in order to identify similar elements.

### DESCRIPTION OF THE PREFERRED EMBODIMENTS

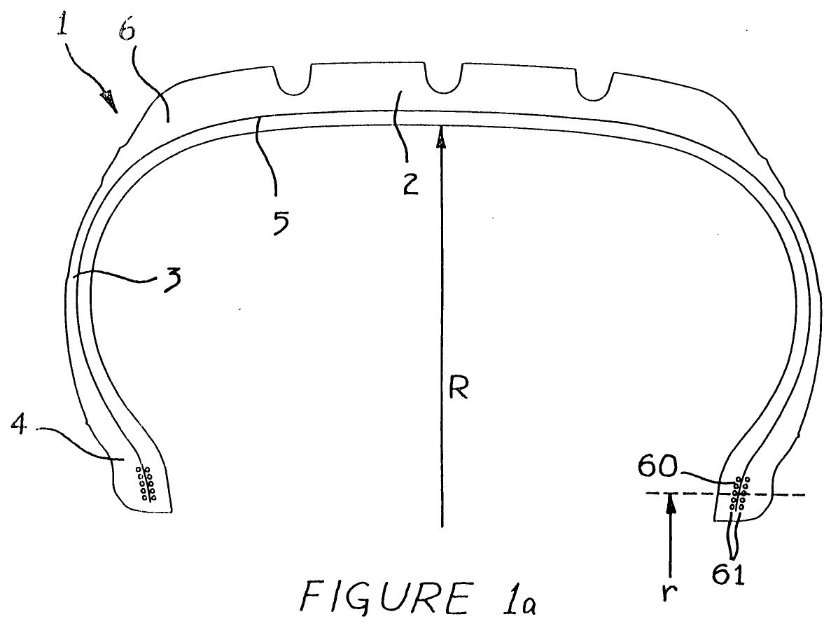

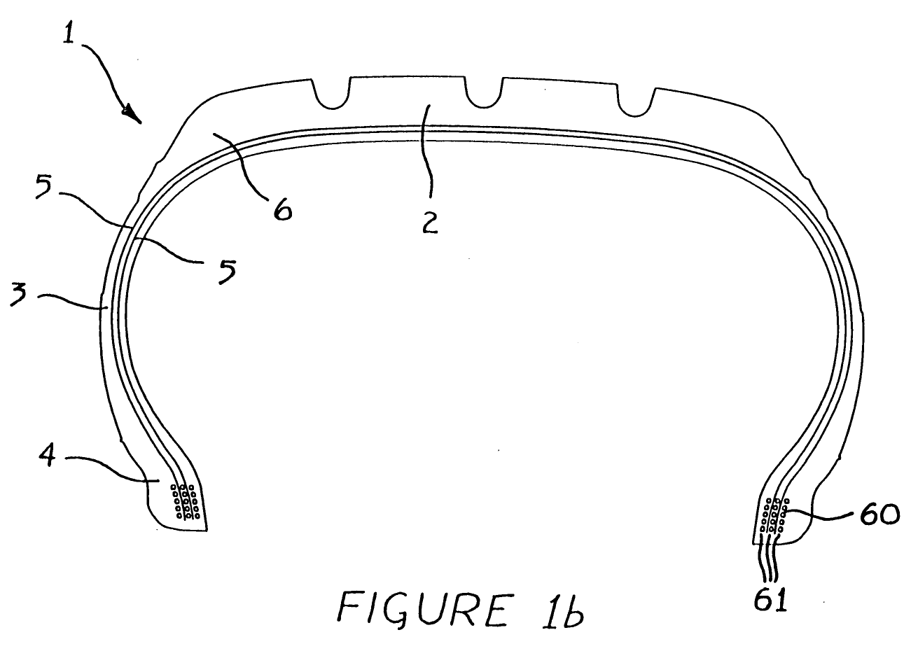

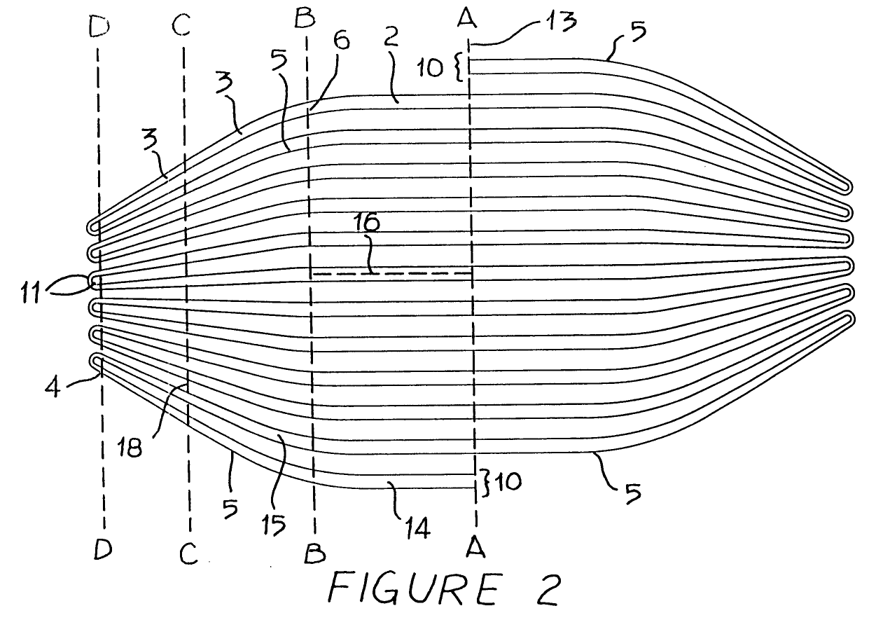

FIGS. 1a, 1b and 2 illustrate a first embodiment of the tire 1 according to the invention. The main constituent elements are clearly visible in FIGS. 1a and 1b, which show a section showing the profile of the tire 1. This comprises sidewalls 3, on either side, surmounted by a crown 2, joining the two radially upper portions of the sidewalls 3.

In the radially inner portion of the sidewalls 3, there are located beads 4, provided for mounting on a rim of suitable form and dimensions.

In order to ensure perfect anchoring of the reinforcement structure, preferably a stratified composite bead is produced. Within the bead 4, between the cord alignments of the reinforcement structure, there are arranged circumferentially oriented cords 60. These are arranged in a stack 61 as in the drawings, or in a plurality of adjacent stacks, or in packets, or in any suitable arrangement, depending on the type of tire and/or the desired characteristics.

The radially inner end portions of the reinforcement structure 5 cooperate with the beads. There is thus created anchoring of these portions in said beads so as to ensure the integrity of the tire. In order to promote this anchoring, the space between the circumferential cords and the reinforcement structure is occupied by a bonding rubber mix. It is also possible to provide for the use of a plurality of mixes having different characteristics, delimiting a plurality of zones, the combinations of mixes and the resultant arrangements being virtually unlimited.

According to one variant of arrangement, a mix of substantially high elasticity modulus is used in the zone of intersection between the arrangement of cords and the reinforcement structure. By way of non-limitative example, the elasticity modulus of such a mix may reach or even exceed 15 MPa, and even in some cases reach or even exceed 30 to 40 MPa.

This mix is advantageously arranged so as to be in direct contact with the adjacent portions of the reinforcement structure 5. In the conventional configurations, a carcass ply (cord impregnated in a layer of rubber mix) is applied. There therefore results a thin intermediate layer of mix of lower modulus which is located between the mix of high modulus and the portion of reinforcement structure. With direct contact, and therefore without the presence of this thin layer of mix of lower modulus, the impact of the presence of the anchoring mix in the zone is amplified. In fact, the traditional thin layer of lower modulus causes losses of energy, which may cause deterioration of the mechanical properties.

The arrangements of cords may be put together and manufactured in several ways. For example, a stack 61 may advantageously be formed of a single cord wound (substantially at zero degrees) in a spiral over several turns, preferably from the smallest diameter towards the largest diameter. A stack may also be formed of a plurality of concentric cords laid one in another, so that rings of gradually increasing diameter are superposed. It is not necessary to add a rubber mix to ensure the impregnation of the reinforcement cord, or circumferential windings of cord.

In order to position the reinforcement cords as accurately as possible, it is very advantageous to build the tire on a rigid support, for example a rigid core which imposes the shape of its inner cavity. There are applied to this core, in the order required by the final architecture, all the constituents of the tire, which are arranged directly in their final position, without the profile of the tire having to be turned up or folded over during building.

This building may for example use the devices described in Patent EP 0 580 055, and also in French application 00/01394, for the laying of the carcass reinforcement cords, and in document EP 0 264 600 for the laying of the rubber compositions. The tire may be molded and vulcanized as set forth in U.S. Pat. No. 4,895,692.

According to this first example (FIG. 1a), a first and a second reinforcement filament of carcass type 5 are arranged along the circumference of the tire so as to form a reinforcement structure which is partially toric or in the shape of an inverted U when observed along a section of the tire as in FIG. 1a. Thus, each of the filaments extends transversely from one side of the tire to the other. In the different examples of FIGS. 1 to 8, this path is extended from one bead to the other. The circumferential displacement of the filament is provided in the radially innermost portion of the path; the filament is then turned up by substantially 180° so as to ascend the sidewall 3, cross the crown zone 2, then be extended radially towards the inside along the opposite sidewall, up to a radial position substantially symmetrical to that of the first sidewall. The filament is then turned up by substantially 180° in order to recommence a new path from one side to the other in similar fashion. The upturns form connections 11, advantageously in the form of a U, but possibly at a more acute angle or alternatively in a less regular form.

The first and second filaments are arranged circumferentially in similar manner, but in slightly offset circumferential positions, so as not to be superposed over great lengths. As illustrated in FIG. 2, the filaments advantageously form groups 10 of filaments. In the example of FIG. 2, these are groups of two filaments. A first “forward” section 14 enables the group to extend from the crown 2 towards one of the sidewalls 3. At the upturn zone, the two filaments of the group are turned up to form connections 11. In order to position a plurality of substantially close connections, a first connection is placed radially internally, then a second connection is placed radially externally.

In the case in which more than two connections are present, they are positioned successively from a first, radially outer, connection to a second, then a third, etc, always more towards a radially inner position. Thus a sort of multi-connection arrangement is formed, with an external connection inside of which is located one or more internal connections, all arranged one in another.

Beyond the connection, the group of cords follows its trajectory towards the crown, forming a second “return” section 15. The succession or alternation of connections from one bead to the other is such that a first connection formed on a first internal filament 5 in a first bead is arranged radially externally in the second bead, for a circumferential position substantially close to the first connection. This is illustrated clearly in FIGS. 2 to 6.

FIG. 1a shows a variant with a single reinforcement structure 5, whereas FIG. 1b shows a variant comprising two structures, one an internal and the other an external structure, separated by a layer of rubber mix.

In each of the sections 14 and 15, the groups each comprise at least a portion of substantially parallel paths 16, in which the two adjacent filaments of one and the same group move along substantially parallel trajectories.

FIG. 2 illustrates an example of embodiment in which the portions of substantially parallel paths 16 are substantially included between the median portion 13 of the crown, along the line A-A, and the region of the shoulder 6, along the line B-B.

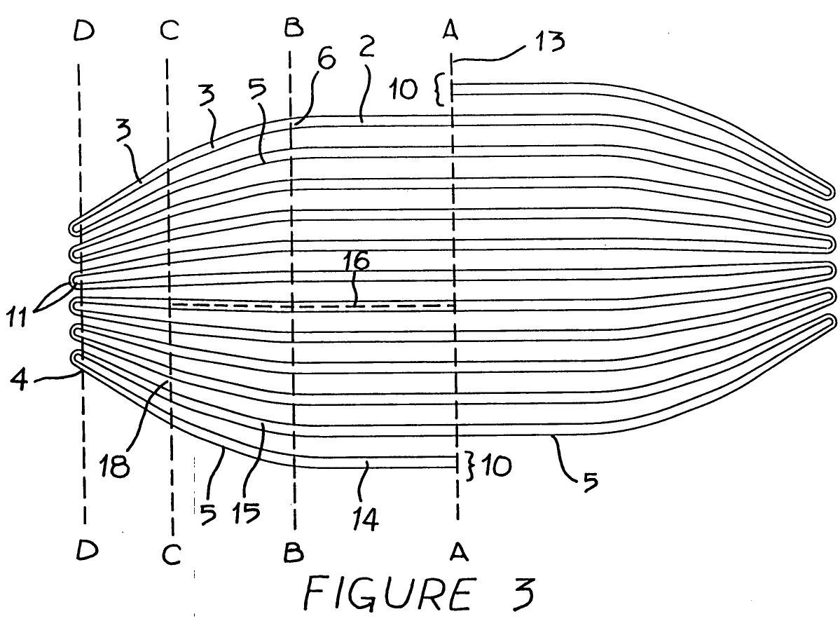

FIG. 3 illustrates an example of embodiment in which the portions of substantially parallel paths 16 are substantially included between the median portion 13 of the crown, along the line A-A, and the region of the equator, along the line C-C.

In these two examples, the circumferential distance between two adjacent filaments or filaments of one and the same group 10 is less than the distance between two adjacent filaments each belonging to two distinct groups.

Due to the substantially radial trajectories of the cords, which in fact are similar to substantially meridian trajectories, for a given pitch P, the circumferential distance between two adjacent groups of cords varies substantially regularly between the bottom zone and the region of the crown of the tire. Most frequently, due to the smaller radius in the bottom zone of the tire, the filaments there are closer to each other. As the crown is approached, the radius becomes larger and the filaments then have more circumferential space between them. FIGS. 2 to 7 clearly show this context since these are projections in the plane of arrangements which are intended to occupy a spatial position such that the crown zone is on a first radius R and the zone of the bead 4 is positioned on another radius r which is smaller than the first radius R. The substantially toric form of a tire makes this type of variation of radius inevitable. It is therefore unthinkable in practice to have a constant inter-cord distance between R and r.

The present invention goes against this teaching since the distance between two cords is maintained over a given portion, by forming groups. In return, the distance between the cords of two adjacent groups varies substantially between the radial positions R and r so as to compensate for the parallel portions of the groups.

Industrial production rates and productivity constraints are nowadays such that very high manufacturing speeds are required and mean that the regularity of laying is not absolute. The mechanical demands of the product furthermore tolerate a certain margin as far as accuracy is concerned, without in any way adversely affecting the final quality. Thus, according to the invention, a tire may comprise cord arrangements having cord trajectories of a regularity which is less than that illustrated in the figures.

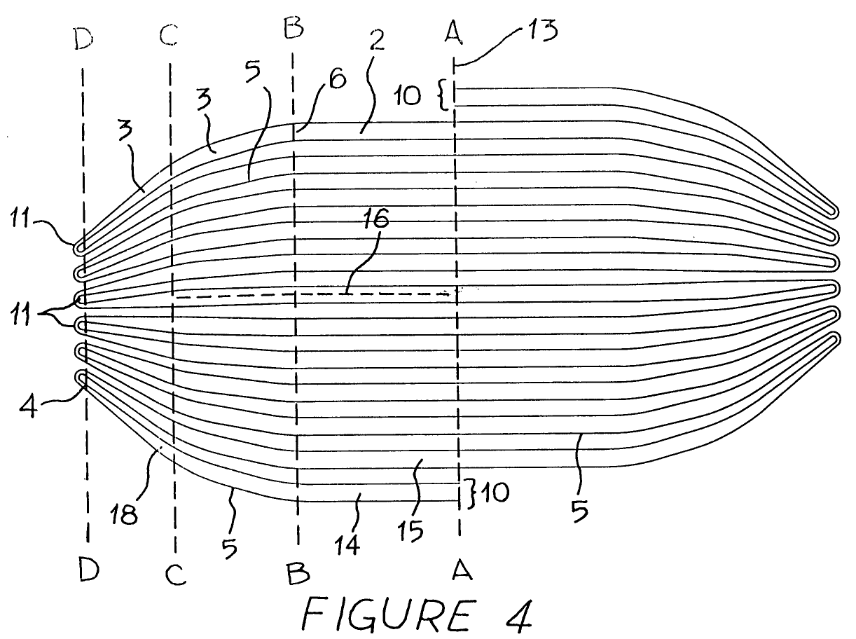

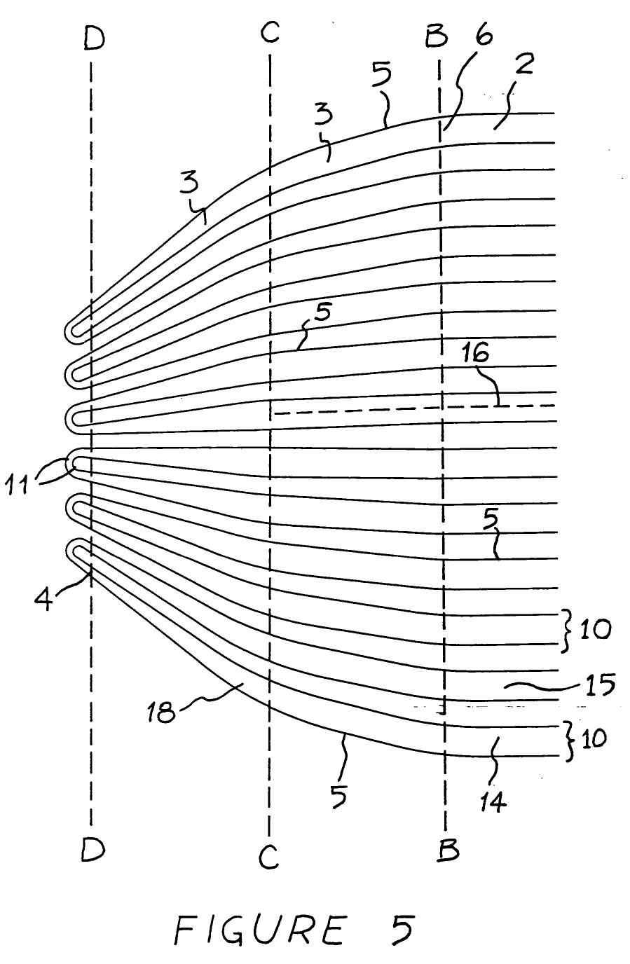

FIG. 4 shows another example of embodiment in which the circumferential distance between two adjacent filaments or filaments of one and the same group is greater than the distance between two adjacent filaments each belonging to two adjacent groups. In order better to visualize the effect created by this type of configuration, FIG. 5 illustrates an arrangement similar to that of FIG. 4, but in a partial, enlarged view.

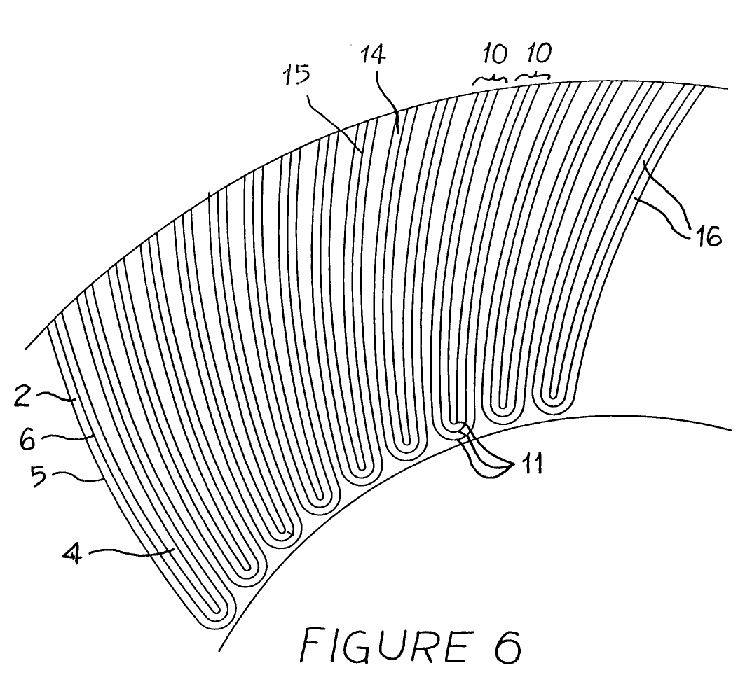

FIGS. 6 to 8 illustrate various examples of embodiment in which groups of cords are arranged along different paths of bias type.

FIG. 6 shows a side view of a variant in which each group 10 comprises three cords 5 along paths of bias type (non-radial). The portions of substantially parallel paths 16 may extend substantially from one bead to the other. The compensation of dimension in order to pass from the smaller radius r to the external radius R takes place owing to an increasing inter-group distance from the bead towards the crown. According to various variants (not shown), the number of cords per group may be different, for example two cords, four cords or more.

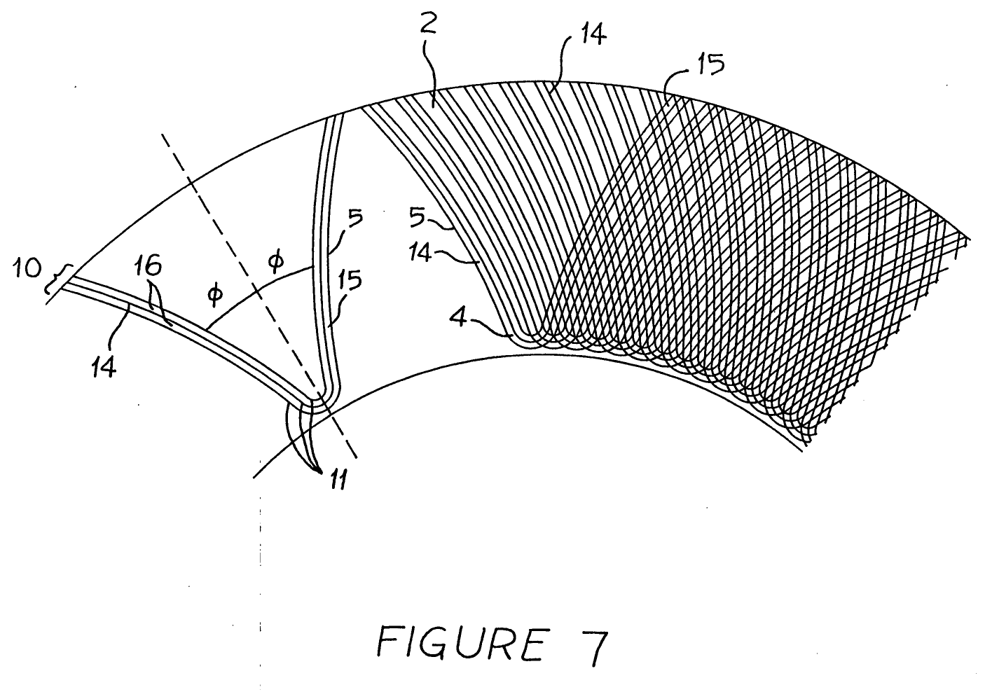

FIG. 7 illustrates another type of configuration of bias type, in which the groups 10, after a first “forward” section 14 from the crown 2 towards a first bead 4 at a given angle ø relative to a substantially radial straight line, form an upturn or connection 11 to return towards the crown. When measured at the same radial position as the angle ø of the “forward” section, the “return” section 15 forms an inverse angle (−ø) compared with the “forward” section.

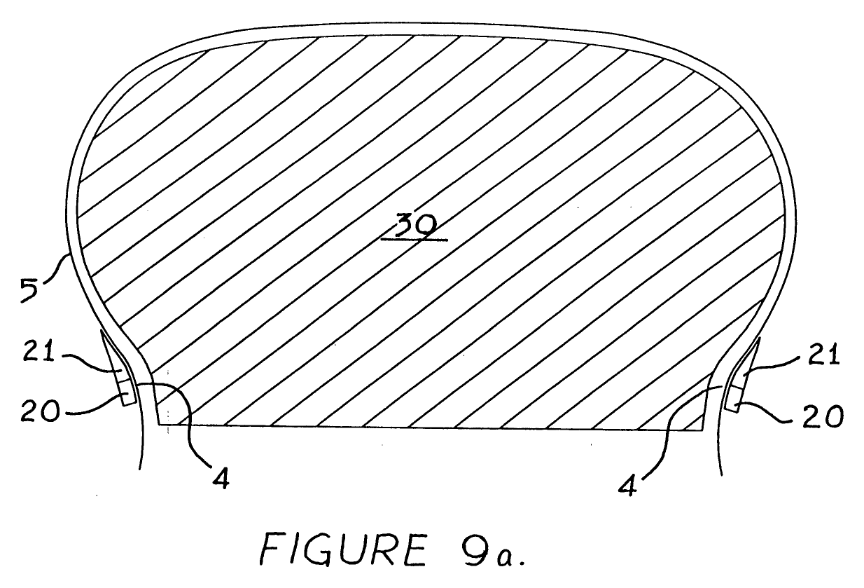

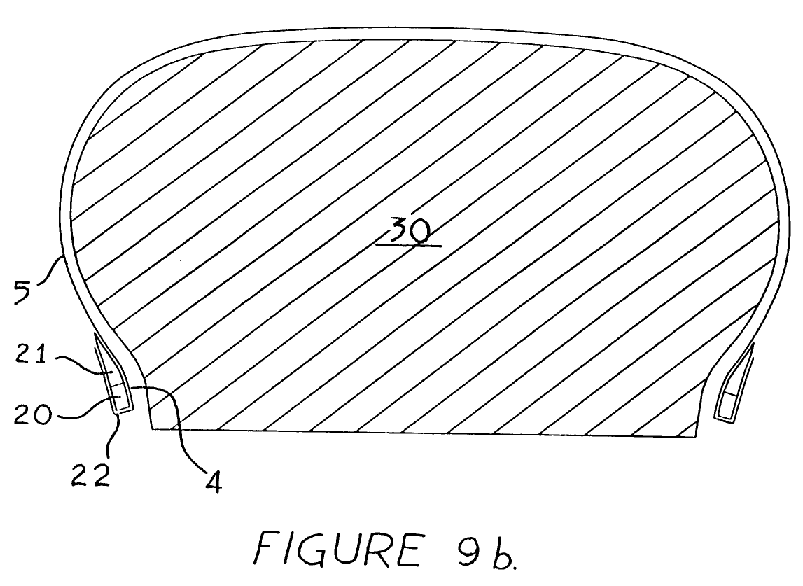

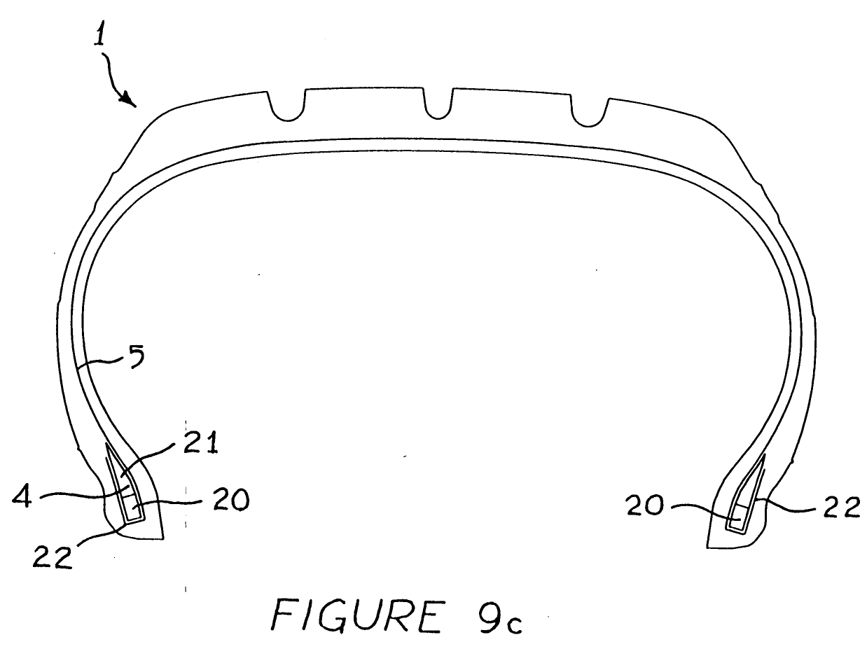

The angle ø may vary for example between 5 and 45 degrees, according to the case. The left-hand portion of FIG. 9 clearly illustrates an example of the path of a group 10 which has been isolated from the others in order to facilitate comprehension. The right-hand portion of the same figure illustrates the resulting arrangement when the groups 10 constituting the reinforcement structure are arranged side by side in the circumferential direction. On this portion, it can be seen that the “return” sections form a woven or grid pattern by passing above or below the “forward” sections.

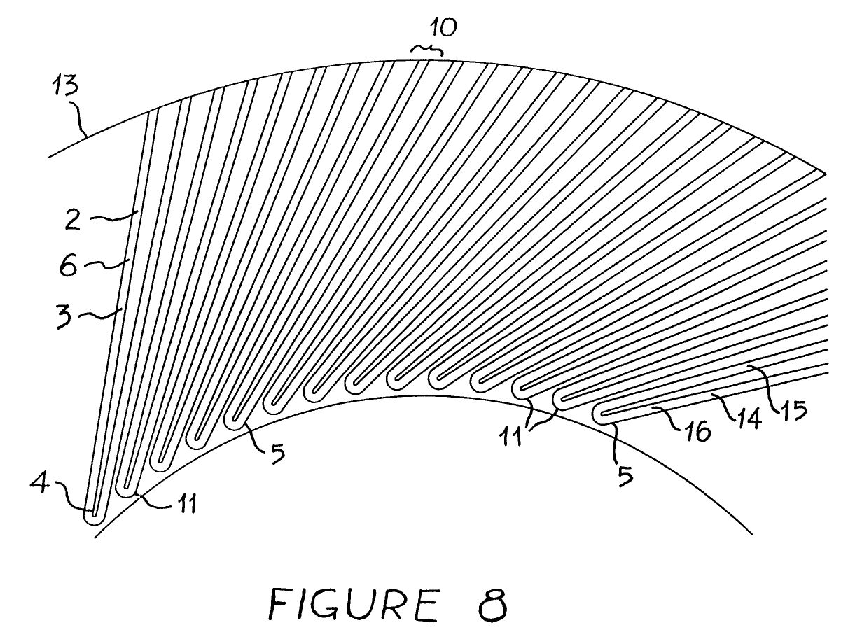

FIG. 8 illustrates another variant of configuration of bias type in which groups of two cords 5 follow substantially geodesic paths.

In the examples illustrated in FIGS. 6 to 8, the groups of cords 5 comprise portions 16 of substantially parallel paths extending substantially from one bead of the tire to the other. According to various variants (not shown), these portions 16 may be limited, for example from one equator to the other, or from any point of a first sidewall towards a symmetrical point on the other sidewall.

FIGS. 9a, 9b and 9c are meridian profiles of a variant comprising a conventional bead wire 20, for example formed of a metal or composite cable. In 9a, the cords 5 can be seen passing along a central core against which the various constituent elements of the tire are applied in succession. The cord passes from one bead 4 to the other and is extended radially internally relative to the bead wire 20. The arrangements of the cords 5 in groups 10, in “forward” 14 and “return” 15 portions forming connections 11 at the level of the beads may, at this stage of manufacture, be comparable or similar to those shown in FIGS. 1 to 8. Thus, the connections 11 may be located radially internally to the bead wire 20.

In 9b, there can be seen the upturn of the cord 5, first of all against the radially inner portion of the bead wire 20, then against the axially outer portion of this bead wire, in order substantially to surround or envelop the latter. The upturned portion 22 advantageously comprises all the connections 11.

As shown in FIG. 9c, the remaining elements constituting the tire are then applied so as to form a tire 1 according to the invention and the central core may be withdrawn, preferably after vulcanization.

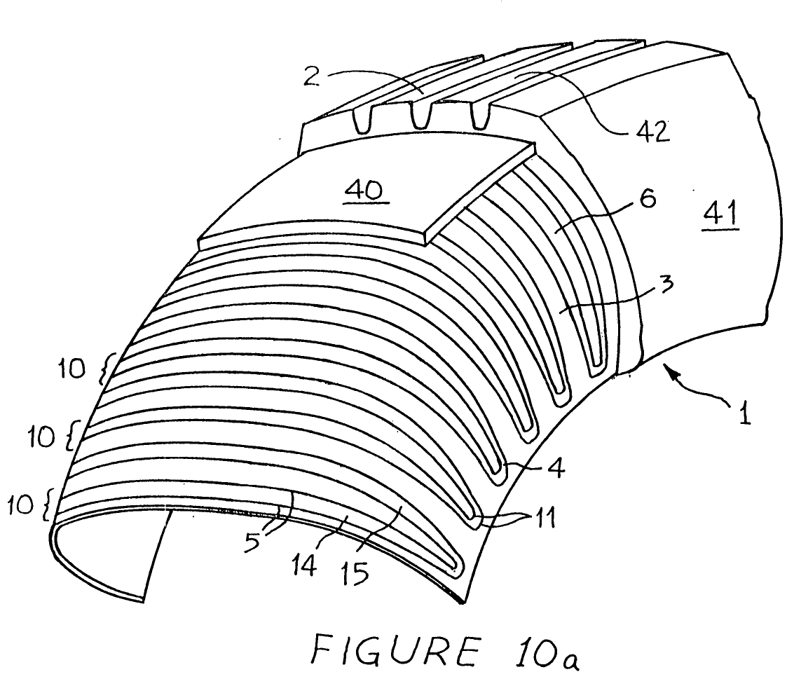

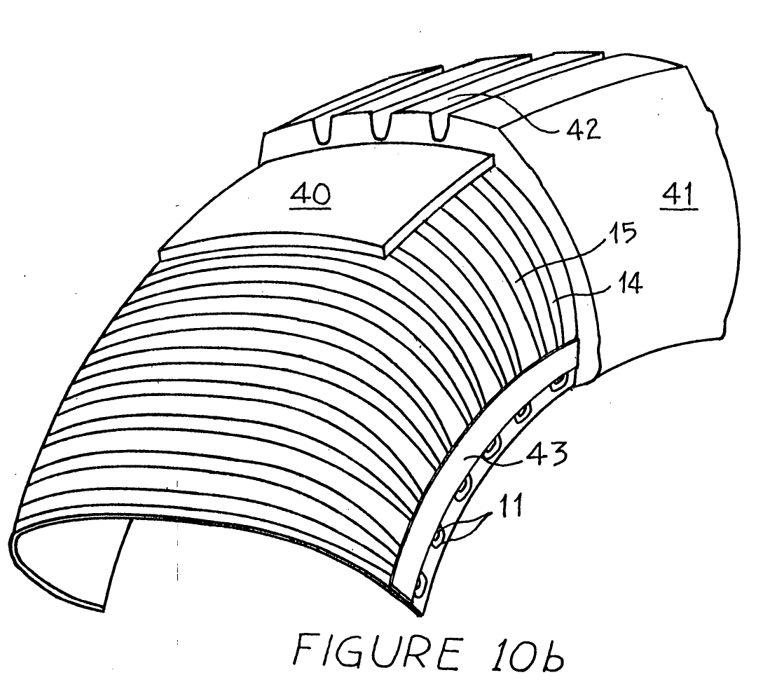

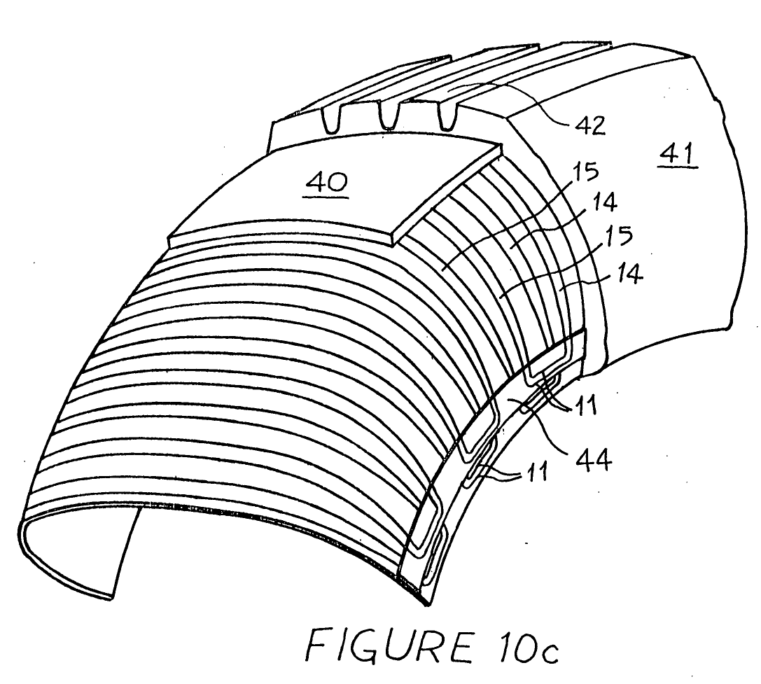

FIG. 10a illustrates a perspective view of the form of embodiment shown in FIG. 3. In addition to the elements previously described, FIG. 10a shows a portion of a layer or crown ply 40, extending circumferentially over a portion of the crown 2 of the tire. Such a ply advantageously comprises at least one type of reinforcement, for example of textile type, arranged in the ply in an arrangement substantially at 0° in the circumferential direction or alternatively at a given angle, fixed or variable, relative to this same direction. A tread 42 and a layer for protecting the sidewalls 41 finish off the product.

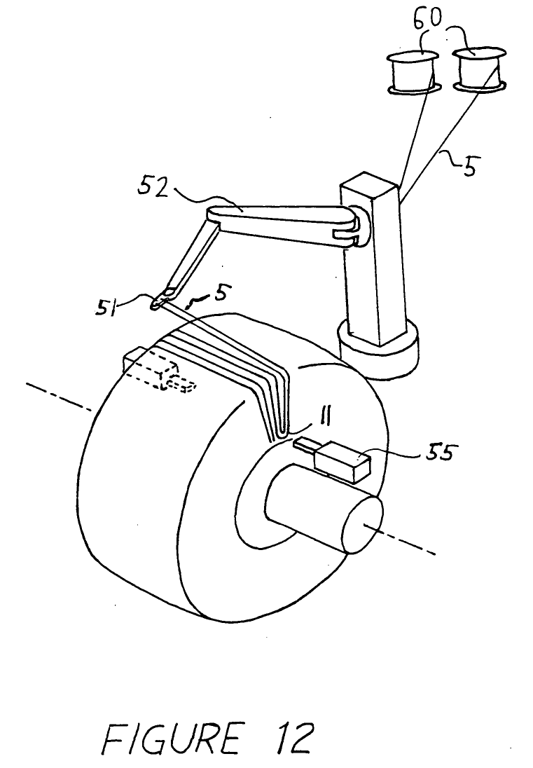

FIGS. 10b and 10c illustrate variants of FIG. 12a in which examples of anchoring of the reinforcement structure in the beads are illustrated. In 10b, the anchoring zone 43 is applied against the base of the cords 5, preferably leaving a layer of rubber mix between the cords 5 and the cord(s) of the anchoring zone. The anchoring zone is preferably as previously described. A sandwich arrangement, such as in FIG. 1a, with stacks on either side of the reinforcement structure may also be provided.

The variant of FIG. 10c comprises an interlaced zone 44 between the bases of the reinforcement structure. The bottom or radially inner portion of a section comprises in alternation a first set of connections 11 arranged axially externally relative to the zone 44 and another set of connections 11 arranged axially internally relative to the zone 44. This axial separation makes it possible to place a larger number of cords even when the radius is small. The mechanical properties such as rigidity may also be optimized. As illustrated in 10c, in this variant, the “forward” 14 and “return” 15 portions of a group of cords 15 are advantageously spaced and separated by at least one “forward” and/or “return” portion of another group of cords. In addition to being spaced axially, successive sets of connections 11 may also be offset radially, for example forming groups of two connections, each group being spaced radially from another, as illustrated in FIG. 10c.

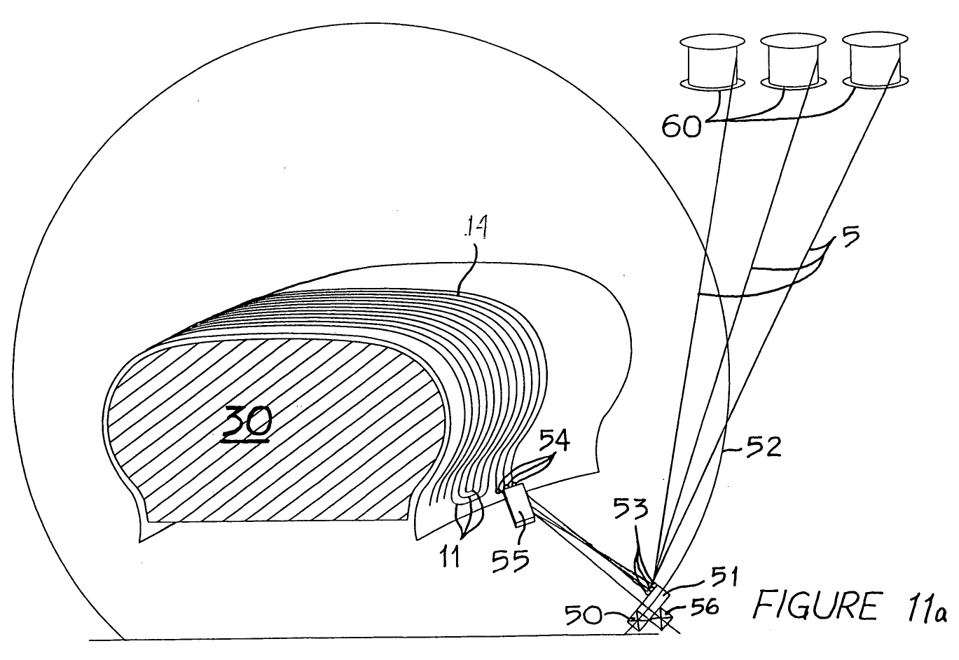

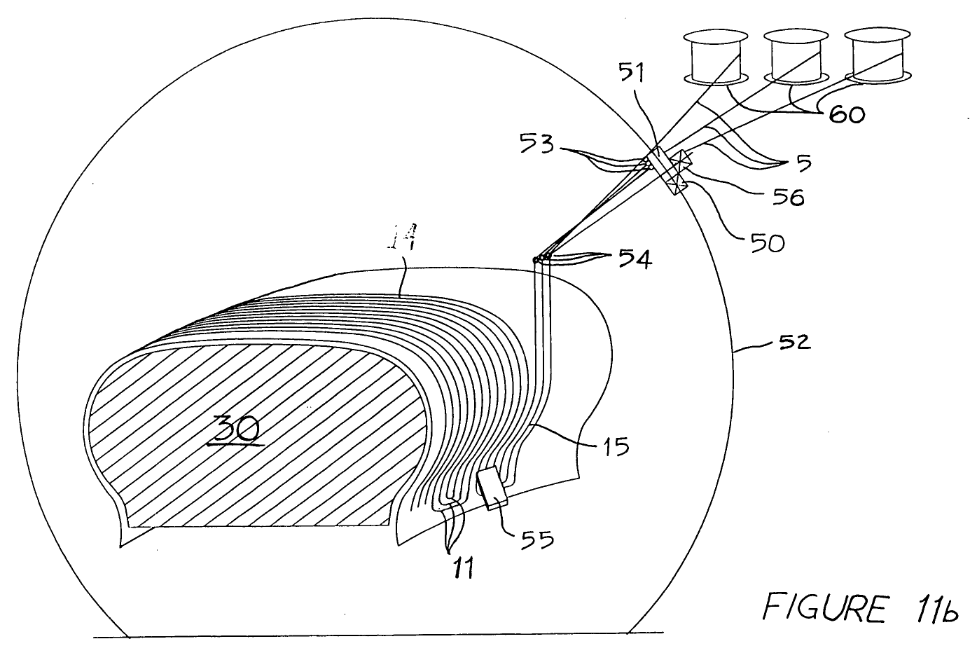

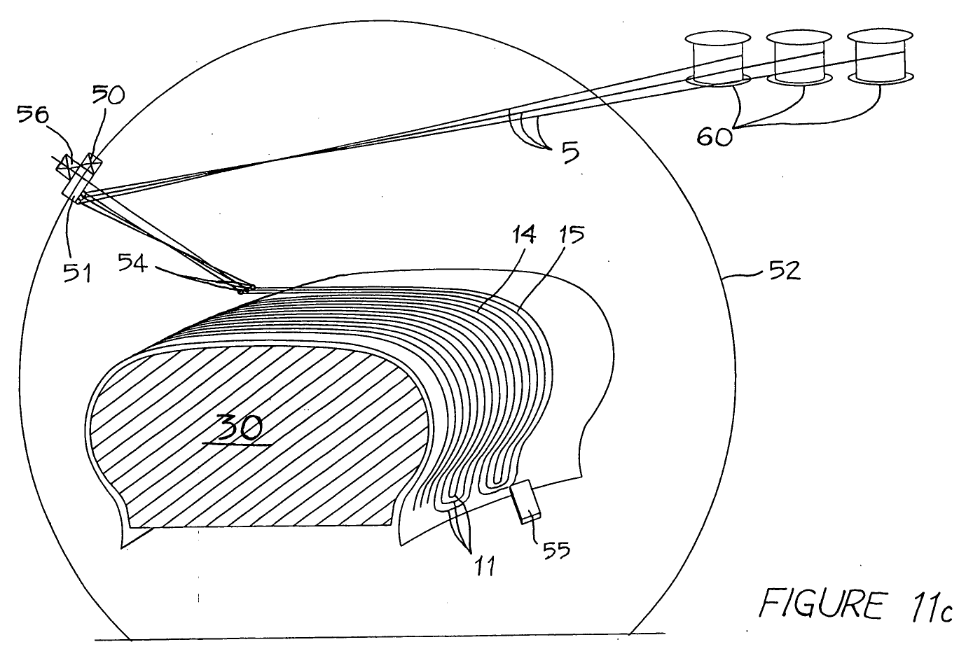

FIGS. 11a and 11d illustrate an example of a method which permits the manufacture of tires such as those described in the preceding figures, with the substantially simultaneous laying of at least two cords 50. Using this method facilitates obtaining portions of substantially parallel paths such as previously described. Storage or supply means make it possible to bring in two, three (or even more) cords which are to be applied to a first layer of rubber mix formed substantially in the image of the profile of the final product. Before application, the cords are arranged in the immediate vicinity of each other at distances corresponding substantially to the distance provided between the cords of one and the same group. For application of the cords against the mix, the laying means moves in space, for example from one bead to the other, along the path which the cords to be laid have to follow in the tire.

Thus, a group of cords is guided by a laying means for application along a predefined path. The laying may be effected either by guiding the group to a substantially infinitesimal distance from the product intended to receive the cords, or by compaction or by application of a laying force by means of a suitable tool until it comes into contact with the rubber mix previously applied. This mix is preferably adhesive, thus enabling the group of cords to be retained or held in place once slight contact is produced between the cords and the rubber mix. The group is therefore guided from one bead of the tire to the other, moving over the sidewalls and the crown.

Once laid as far as a radially lower portion of a bead, thus forming a “forward” section, the group of cords is guided so as to move circumferentially or angularly, to enable the group of cords to move over the profile in a path substantially adjacent to the “forward” portion to form a “return” section, extending as far as the opposite bead.

Furthermore, FIGS. 11a to 11d diagrammatically illustrate a mechanism which makes it possible to lay groups of cords such as described above. Reserves 60 of cords enable the laying mechanism to be supplied. The latter comprises a series of guide means 53, 54 (preferably as many means as there are cords to be laid), which are preferably mobile from one side of the tire to the other, actuated by a control means 50, 51, 52. In the example illustrated, the control means comprises a first motor means 50 and transport elements 51 and 52, such as, for example, a slider which moves on a rail, enabling the guide means 53, 54 for the cords 5 grouped for example in twos or threes (as illustrated) to be moved in space.

FIG. 11a illustrates an example of displacement of the guide means of one side of the tire. Guiding as close as possible of the profile as far as the level of the bead makes it possible to effect advantageously precise, regular laying. The guide means bring the cords into the bottom position; a relative angular displacement between the guides 54 and the tire being assembled makes it possible to move the cords in translation to form the connections 11. In order to do this, the guide means 54 are advantageously driven in rotation on themselves, so as to form the connections 11, for example using a second motor means 56.

To facilitate the respective positionings between the sidewall and the laying members, it may also be arranged that, during the rotation of the guide means 54, either the tire undergoes a rotation of several degrees, or the guide 54 is displaced along the bottom zone, or a combination of both. According to an advantageous variant, such as illustrated, a press element 55 exerts a slight pressure against the base of the cords before shaping the connections. Thus any accidental sliding or displacement of the cords during laying is avoided.

FIG. 11b shows the development of the path several moments later, when a connection has been produced, and the guide 54 re-ascends along the sidewall in order to lay another section, circumferentially spaced apart from the previous one.

FIG. 11c illustrates the same tire, when the slider arrives at the opposite side; the guide 54 carries the cords into the region of the shoulder. The laying along the opposite sidewall and the production of the corresponding connections is effected similarly to that previously described for the first sidewall.

According to an advantageous variant, the distance between the cords before laying is variable or adjustable, so to as make it possible to lay the cords with larger or smaller inter-cord spaces depending on the types of products, or even with variable spaces on one and the same product, for example as a function of the position on the profile.

FIG. 12 illustrates an advantageous variant in which the guide means 54 are arranged on an arm or multi-axis robot capable of displacing said means 54 along the path of the filaments 5. The forward 14 and return 15 sections and the connections 11 are arranged and produced similarly to what has been discussed for FIGS. 11a to 11c.

1. A tire comprising at least one reinforcement structure of carcass type anchored on either side of the tire in a bead, the base of which is intended to be mounted on a rim seat, a crown reinforcement, each bead being extended radially towards the outside by a sidewall, the sidewalls joining a tread radially towards the outside, the reinforcement structure comprising:
a first filament forming on one hand at the level of the crown and the sidewalls a series of transverse portions extending substantially from one bead of the tire to the other, and on the other hand, at the level of the beads, U-shaped connections joining two successive transverse portions of the first filament,
a second filament forming on one hand at the level of the crown and the sidewalls a series of transverse portions extending substantially from one bead of the tire to the other, and on the other hand, at the level of the beads, U-shaped connections joining two successive transverse portions of the second filament,
the first and second filaments being arranged so that, for a given circumferential position of the tire, in a first bead, the first filament forms a radially outer connection, radially inside of which an internal connection formed by the second filament is arranged, and, in the second bead, the second filament forms a radially outer connection, radially inside of which an internal connection formed by the first filament is arranged, there being no contact between the filaments.

2. The tire of claim 1, wherein the respective paths of the first and second filaments are arranged such that, between the crown and the bead, a group of filaments formed by a first and a second adjacent filament forms at least a portion of substantially parallel paths.

3. The tire of claim 2, wherein the portions of substantially parallel paths are provided in the sidewall, substantially radially externally to the anchoring zone.

4. The tire of claim 2, wherein the portions of substantially parallel paths are provided substantially radially externally to the equator of each sidewall.

5. The tire of claim 2, wherein the portions of substantially parallel paths follow substantially geodesic trajectories.

6. The tire of claim 2, wherein the portions of substantially parallel paths represent at least substantially 25% of the total path of the filaments between the crown and the anchoring zone.

7. The tire of claim 6, wherein the portions of substantially parallel paths represent between substantially 30% and 80% of the total path of the filaments between the crown and the anchoring zone.

8. The tire of claim 1, comprising a third filament forming on one hand, at the level of the crown and the sidewalls, a series of transverse portions extending substantially from one bead of the tire to the other, and on the other hand, at the level of the beads, U-shaped connections joining two successive transverse portions of the third filament.

9. The tire of claim 8, wherein the respective paths of the first, second and third filaments are arranged such that, between the crown and the bead, a group of filaments formed by a first, a second and a third adjacent filament forms at least a portion of substantially parallel paths.

10. The tire of claim 1, wherein the “forward” and “return” sections of at least two distinct groups cross to form a mesh pattern of filaments.

11. The tire of claim 1, wherein at least one arrangement of filaments along a substantially circumferential path is arranged substantially adjacent to said reinforcement structure at the level of the bead.

12. The tire of claim 1, wherein said filaments have substantially parallel paths in the upturn loop.
